(19) United States
(12) Patent Application Publication
(10) Pub. No.: US 2026/0360274 A1
(43) Pub. Date: Nov. 12, 2026

(54) Systems and Methods for Multi-Domain AI Driven Virtual Training Environment

(71) Applicant: THE PENN STATE RESEARCH FOUNDATION, University Park, PA (US)

(72) Inventor: Jacob Holster, State College, PA (US)

(21) Appl. No.: 19/675,428

(22) Filed: May 12, 2026

Related U.S. Application Data
(60) Provisional application No. 63/804,386, filed on May 12, 2025.

(51) Int. Cl. G09B 9/00; G06F 3/01; G06F 3/16; G06T 11/00; G10L 15/183; G10L 15/22

(52) U.S. Cl. CPC G09B 9/00; G06F 3/011; G06F 3/167; G06T 11/00; G10L 15/183; G10L 15/22; G06T 2200/24; G10L 2015/223

(57) ABSTRACT

A method for generating a virtual reality training environment is described herein. The method includes receiving a selection of a domain for a virtual reality environment from a plurality of domains from a user via a user device, retrieving a plurality of domain parameters associated with the domain, generating the virtual reality training environment by inputting the plurality of domain parameters into a virtual reality machine learning model, and displaying the virtual reality training environment to the user via the user device.

### CROSS-REFERENCE TO RELATED APPLICATIONS

This application claims the benefit of U.S. Application No. 63/804,386, filed May. 12, 2025, and entitled “Systems and Methods for Multi-Domain AI Driven Virtual Training Environment”, which is incorporated herein by reference in its entirety.

### FIELD OF THE DISCLOSURE

The present disclosure relates generally to virtual reality and, more particularly, to methods and systems for generating adaptive virtual reality training environments using language models.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Preservice professionals in helping fields such as education, healthcare, and counseling often face limited access to diverse real-world training experiences. While traditional methods such as roleplaying and fieldwork offer some experiential learning, these approaches often lack consistency, adaptability, and immersive depth. Many existing training platforms frequently rely on rigid decision trees or scripted interactions that fail to capture the fluid, dynamic nature of human behavior and contextual variability. In particular, the behavior of virtual characters in such systems is typically rule-based or deterministic, providing limited flexibility in responding to user input beyond predefined interaction paths. To introduce dynamic behavior, developers must manually input hundreds or thousands of potential interactions, resulting in significant memory and computational demands. As a result, there exist significant challenges in developing realistic and responsive training environments capable of adapting in real time to a user’s decisions, emotional tone, or situational context, which are challenges that must be addressed to effectively prepare professionals for the complexities of real-world practice.

### SUMMARY

In some aspects, the techniques described herein relate to a method for generating a virtual reality training environment, the method including: receiving, by one or more processors, a selection of a domain for a virtual reality training environment from a plurality of domains from a user via a user device; retrieving, by the one or more processors, a plurality of domain parameters associated with the domain, the plurality of domain parameters including at least a plurality of training scenarios, one or more domain-specific profiles, contextual domain-specific data, a plurality of potential user actions, and corresponding outcomes; generating, by the one or more processors, the virtual reality training environment by inputting the plurality of domain parameters into a virtual reality machine learning model, wherein the virtual reality training environment includes one or more characters and a training setting based on the plurality of domain parameters; and displaying, by the one or more processors, the virtual reality training environment to the user via the user device.

### BRIEF DESCRIPTION OF THE DRAWINGS

FIG. 1 illustrates a block diagram of an example communication system in which a method for generating a virtual reality training environment can be implemented;

FIG. 2 illustrates a block diagram of an example language model server that may operate in the system of FIG. 1;

FIG. 3 illustrates a block diagram of an example training environment server that may operate in the system of FIG. 1;

FIG. 4A illustrates a combined block and logic diagram that depicts a generation of a virtual reality training environment;

FIG. 4B illustrates a combined block and logic diagram that depicts updating a virtual reality training environment based on a response generated from a language model;

FIG. 5 illustrates an example communication session between a user device and the language model for an active training environment session;

FIG. 6 is a flow diagram of an example method for generating a virtual training environment.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean...” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Conventional training simulations in virtual reality environments typically rely on static, pre-scripted scenarios with limited interactivity and adaptability. These systems often fail to accommodate the dynamic and unpredictable nature of real-world situations faced by professionals in education, healthcare, and counseling. In particular, the behavior of virtual characters in such environments is generally rule-based or deterministic, offering little flexibility in responding to a user’s input beyond predefined branches. As a result, these conventional systems struggle to deliver a responsive learning experience that adapts in real time to the user’s decisions, emotional tone, or evolving context within a training session.

Broadly speaking, the techniques of the present disclosure relate to a virtual reality training system for generating a virtual reality training environment. In operation, the virtual reality training system may receive a selection of a domain (e.g., education) for a virtual reality training environment from a plurality of domains (e.g., education, healthcare, counseling, etc.). The virtual reality training system may then retrieve a plurality of domain parameters associated with the domain. The plurality of domain parameters may comprise a plurality of training scenarios, one or more domain-specific profiles, contextual setting data (i.e., contextual domain-specific data), a plurality of potential user actions, and corresponding outcomes. The virtual reality training system may then generate the virtual reality training environment by inputting the plurality of domain parameters into a virtual reality machine learning model. The virtual reality training environment may comprise one or more characters and a training setting based on the plurality of domain parameters. For example, the virtual reality training system may create an elementary school virtual reality training environment with virtual students as one or more characters, and a classroom as the training setting. The virtual reality training system may then display the virtual reality training environment to a user via a user device.

The present techniques improve upon the limitations of the conventional training simulations by integrating a large language model (LLM) into virtual reality (VR) training simulations to support adaptive, context-sensitive responses and dynamic scenario progression. Unlike conventional VR simulations with hardcoded interactions, the virtual reality training system may accept naturalistic user inputs, such as spoken commands or selectable options, and may generate real-time responses from virtual characters that account for both contextual setting and user’s behavior. For example, virtual characters may respond differently based on the tone, wording, and timing of the user's intervention, as well as the contextual state of the environment, such as whether the setting is calm and orderly or loud and chaotic. Such techniques improve the realism and depth of the training experience, while enabling users to explore multiple decision paths and their downstream consequences without requiring the scenario to be manually reprogrammed.

By leveraging the capabilities of a language model in conjunction with domain parameters (e.g., domain-specific profiles, training scenarios, etc.), the virtual reality training system allows virtual characters (e.g., domain-specific profiles) to exhibit a diverse range of both verbal and nonverbal behaviors, including customized tone, gesture, and posture. These features adapt fluidly in response to user actions, resulting in a more realistic interpersonal experience. For example, a character may respond to user feedback with a frustrated tone and crossed arms when the user makes a dismissive comment, or may brighten in posture and speech when offered empathetic responses. Such behavioral fidelity is difficult to achieve with traditional rule-based avatar systems and contributes directly to improved training outcomes in empathy, situational awareness, and communication.

From a system performance perspective, the present techniques improve the efficiency and responsiveness of virtual training platforms by reducing the overhead associated with manual scenario scripting and rigid branching logic. Instead of requiring developers to predefine all possible user interactions, the virtual reality training system utilizes a large language model (LLM) to interpret user input and generate contextually appropriate responses in real time. This dynamic response generation significantly reduces the manual development burden while enabling more flexible and scalable simulation workflows.

Additionally, because the system no longer needs to store or manage exhaustive trees of scripted interactions, the system may reduce memory consumption and persistent storage requirements typically associated with pre-authored dialogue paths and scenario logic. Instead of maintaining large libraries of predefined responses and branching conditions locally or across networked components, the system may leverage generalizable language model parameters to dynamically generate contextually appropriate outputs using a language model. Such system not only conserves memory resources but also reduces the complexity of maintaining and updating the libraries of predefined responses. Moreover, by generating responses on demand, the system may avoid repeated transmission of large interaction datasets (e.g., user decision histories) between the client device, the training environment server, and the language model server. This on-the-fly processing significantly reduces bandwidth usage and minimizes latency, leading to faster, more efficient communication and improved real-time responsiveness across distributed system components.

In addition to generating verbal responses, the virtual reality training system may also update elements of the virtual reality training environment—including the setting and the behaviors of virtual characters—based on the output of the LLM. These updates may include modifications to character tone, facial expressions, posture, and environmental cues, allowing the simulation to reflect emotional nuance and situational complexity. As a result, users experience more human-like interactions that combine both verbal and nonverbal feedback, supporting richer engagement and more realistic professional training experiences.

As a result of these improvements, the present techniques offer a technical advance over existing simulation platforms by providing a scalable, context-aware, and emotionally responsive VR training environment. These technical enhancements not only elevate the realism and adaptability of the simulation but also reduce the manual engineering cost of developing and maintaining diverse training scenarios, thereby making the virtual reality training environment to be faster, more efficient, and more realistic. By integrating language model into virtual environments, the virtual reality training system achieves a more flexible and intelligent simulation architecture capable of meeting the varied and evolving needs of modern professional training.

### Example Hardware and Software Components

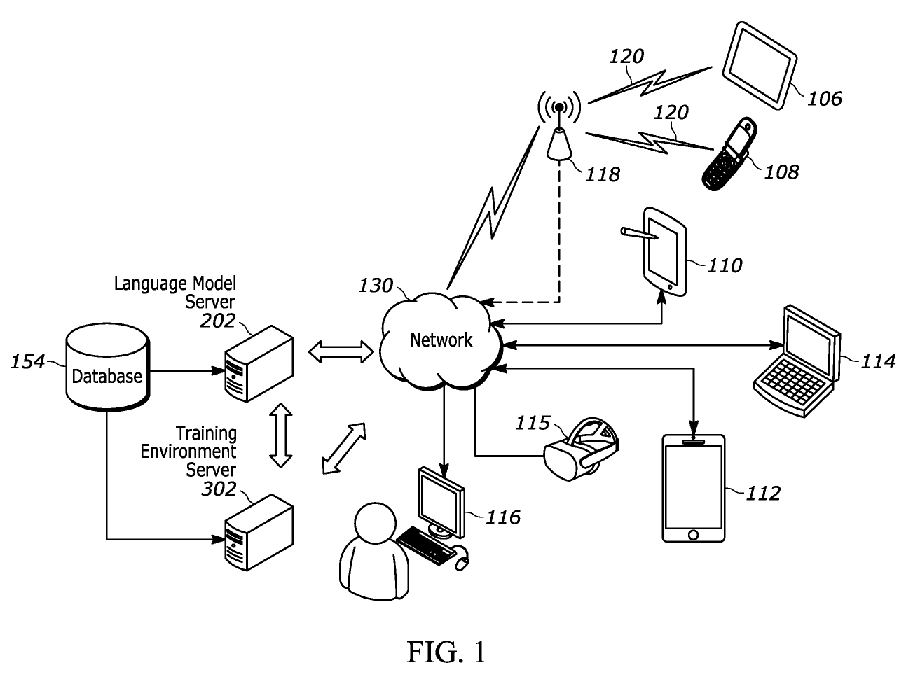

Referring to FIG. 1, an example virtual reality training system 100 includes a language model server 202, a training environment server 302, and client devices 106–116 which may be communicatively connected through a network 130, as described below. The digital network may be any suitable local or wide area network(s) including a Wi-Fi network, a Bluetooth network, a cellular network such as 3G, 4G, Long-Term Evolution (LTE), 5G, the Internet, etc. In some instances, the client devices 106–116 may communicate with the digital network 130 via an intervening wireless or wired device 118, which may be a wireless router, a wireless repeater, a base transceiver station of a mobile telephony provider, etc. The language model server 202 and the training environment server 302, may also communicate with each other over the digital network 130, or may directly communicate with each other in a wired or wireless manner.

The client devices 106–116 may include, by way of example, a tablet computer 106, a network-enabled cell phone 108, a personal digital assistant (PDA) 110, a mobile device smart-phone 112 also referred to herein as a “mobile device,” a laptop computer 114, a wearable computing device (e.g., a virtual reality headset) 115, a desktop computer 116, a portable media player (not shown), a smart watch, a tablet, any device configured for wired or wireless RF (Radio Frequency) communication, etc.

At the start of a training session (e.g., virtual reality training session), a user device (e.g., client device 106–116) may transmit a user input indicating a selection of a domain from a plurality of available training domains (e.g., education, healthcare, counseling). In some embodiments, if no predefined domains are available, the user device may instead provide a user input comprising custom domain parameters for the creation of a new training environment for a specific domain. In some other embodiments, the user device may transmit a user input including specific actions or decisions made in response to a scenario presented within that environment.

Each of the client devices 106–116 may interact directly with the language model server 202 to generate and/or update a training environment. For example, the client device 106–116 may transmit a selection of a training domain (e.g., education) to the language model server 202. In response, the training environment server 302 may communicate with a database 154 to retrieve a plurality of domain-specific parameters associated with the selected domain.

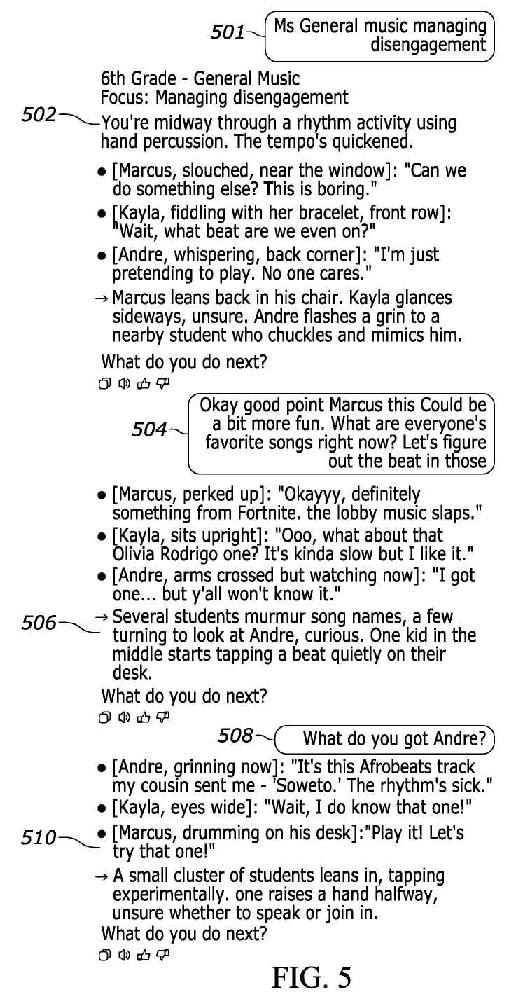

Each of the client devices 106–116 may interact with the language model server 202 to transmit a user input and receive a corresponding response. A user device (e.g., client devices 106–116) may engage directly with the language model server 202 when operating in a non-virtual training environment rather than within a virtual reality training environment. The non-virtual training environment may refer to a training environment that does not illustrate the training environment via virtual reality interface. For instance, a user device may interact with the language model via a language model chat interface, and receive different scenarios and responses in texts. This allows users to access and participate in the training environment without requiring the virtual reality headset 115. Instead, users may engage with the system using standard devices such as a smartphone 112 or a laptop computer 114. Example language model chat interface is discussed in greater detail below with respect to FIG. 5. The user device may access the language model from a variety of environments and contexts, enabling flexible deployment across different training scenarios.

The user device may transmit a user input (e.g., a selection of a domain for a virtual reality training environment or an action performed by a user) to the language model server 202. Upon receiving the user input, the language model server 202 may process the user input using a large language model to generate the corresponding response. For instance, the user input may be “Let’s be quiet and have a seat” and the corresponding response may be “students looked around at each other, and promptly took a seat with student A complaining, student B yawning, and student C looking at the teacher.” In some embodiments, the language model server 202 may construct an input prompt by combining the user input with a plurality of domain-specific parameters associated with the user’s current training domain, and process the input prompt to generate the corresponding response. For example, if the user is participating in an educational training environment, the language model server 202 may generate an input prompt that integrates the user input with relevant educational domain parameters, and process the input prompt to generate the corresponding response. The user’s current training domain may be selected from a plurality of domains from a user via the user device at the start of the training session. For instance, the plurality of domains may be educational training environment, hospital training environment, and construction site environment. The language model server 202 may then transmit the response back to the corresponding client device 106–116. An example of the user device directly communicating with the language model server 202 may be illustrated in FIG. 5.

Each of the client devices 106–116 may interact with the training environment server 302 to generate and/or update a virtual reality training environment. For example, the client device 106–116 may transmit a selection of a training domain (e.g., education) to the training environment server 302. In response, the training environment server 302 may communicate with a database 154 to retrieve a plurality of domain-specific parameters associated with the selected domain. For instance, the domain-specific parameters may include domain-specific profiles, such as virtual characters relevant to the domain; contextual domain-specific data, such as environmental or setting information; and a plurality of domain-specific training scenarios. As an illustrative example, in the classroom domain, the domain-specific profiles may represent various student personas within the classroom, the contextual domain-specific data may include elements of the classroom setting (e.g., seating arrangement, noise level, time of day), and the domain-specific training scenarios may encompass a range of classroom situations, such as managing disruptive behavior, facilitating group activities, or handling emotional outbursts. Based on these parameters, the training environment server 302 may generate a customized virtual reality training environment tailored to the selected domain.

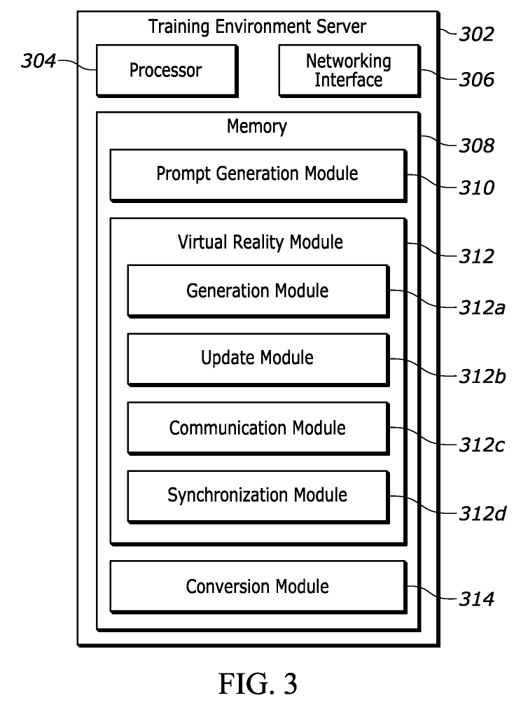

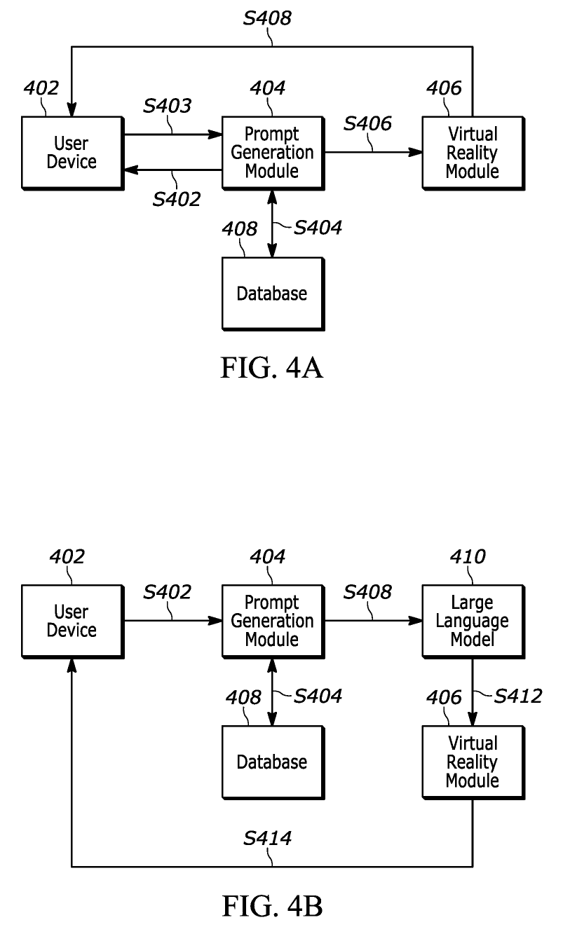

During an active virtual reality training session, the client device 106–116 may transmit user input corresponding to an action taken by the user within the virtual environment. For example, in an education domain training scenario, the virtual classroom may include students in virtual characters who are talking out of turn, prompting the user, acting as the teacher, to instruct the students to quiet down and return to their seats. This directive may be captured as the user input and transmitted to the training environment server 302. The training environment server 302 may then generate an input prompt by combining the user input with a plurality of domain parameters specific to the active training domain (e.g., education domain). This input prompt is transmitted to the language model server 202, which processes the prompt to generate an appropriate, context-sensitive response. The language model server 202 may then transmit the response to the training environment server 302. Upon receiving the response, the training environment server 302 may update the virtual reality training session accordingly. For instance, the training environment server 302 may modify the behavior of one or more virtual characters or alter the training setting. The training environment server 302 may then transmit the response back to the client device 106–116 for display and interaction. Details of the virtual characters being generated and updated based on the response are further described in the virtual reality module 312 of FIG. 3 and the logic diagram of FIG. 4B.

In some embodiments, the language model server 202 and the training environment server 302 may communicate directly with one another. The training environment server 302 may transmit an input prompt comprising user input (received from the user device) and relevant domain parameters to the language model server 202. Upon receiving the input prompt, the language model server 202 may generate a response using its underlying language model. Once the response is generated, the language model server 202 may transmit the response back to the training environment server 302 for further processing or integration into the virtual reality training environment.

The language model server 202 and the training environment server 302 may also be communicatively connected to a database 154. The database 154 may store information associated with users, including individualized user profiles. Each user profile may include a history of the user’s interactions within the training environment, the user’s progression through various training scenarios, performance metrics, decision logs, selected actions, feedback received, and timestamps associated with each session. For instance, if a user is undergoing classroom management training, the user profile may record how the user responded to disruptive behavior, which strategies were employed, and the outcomes of those strategies. The database 154 may also store information of different domains including a plurality of domain parameters for each domain. A domain may represent a specific training environment that a user, via a client device 106–116, may engage in. For instance, a user preparing to become an elementary school teacher may select the “elementary school” domain to access tailored training scenarios relevant to classroom management, student interaction, and pedagogy. Each domain may be associated with a set of domain parameters, which may include a variety of training scenarios, domain-specific character profiles, contextual setting data (i.e., contextual domain-specific data), potential user actions, and corresponding outcomes, all tailored to simulate realistic situations within that domain.

The database 154 may also store analytics related to different training scenarios, including detailed logs of user choices, response patterns, time taken to make decisions, success or failure outcomes, and user engagement metrics. These analytics may capture both individual and aggregate-level data across multiple sessions and users. For example, the training environment server 302 may record how frequently users choose certain dialogue options, whether those options lead to positive or negative outcomes, and how user behavior changes over time or in response to feedback. This information may be analyzed to identify common decision-making trends, areas where users consistently struggle, or scenarios that may require additional instructional scaffolding. The resulting insights may be used to iteratively improve the training environment by refining scenario design, adjusting difficulty levels, modifying character responses, or enhancing feedback mechanisms to better align with real-world expectations and training goals.

The database 154 may also store training data that may be used to improve the performance of both the language model of a language model server 202 and a virtual reality training model of the training environment server 302. For example, the language model server 202 may utilize stored conversational data, domain-specific prompts, and user interaction histories to fine-tune or retrain its underlying language model for greater contextual accuracy and responsiveness. Similarly, the training environment server 302 may use the stored data to train or update the virtual reality machine learning model, enabling more realistic environment generation and adaptive scenario flow. In some embodiments, the training data may include mappings between domain parameters and corresponding virtual reality training environments, allowing the training environment server 302 to learn how to better synthesize environmental elements, character behaviors, and situational dynamics.

The language model of the language model server 202 and the virtual reality machine learning model of the training environment server 302 that use a machine learning model may be configured to implement machine learning, such that the model/engine “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one machine learning method and algorithm may be applied, which may include but is not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of several categorizations of machine learning, such as supervised learning, unsupervised learning, and reinforcement learning.

In one embodiment, the language model and the virtual reality machine learning model may employ supervised learning, which involves identifying patterns in existing data to make predictions about subsequently received data. Specifically, the language model and the virtual reality machine learning model may be “trained” using training data, which includes example inputs and associated example outputs. Based upon the training data, the language model and the virtual reality machine learning model may generate a predictive function which maps outputs to inputs and may utilize the predictive function to generate machine learning outputs based upon data inputs.

In another embodiment, the language model and the virtual reality machine learning model may employ unsupervised learning, which involves finding meaningful relationships in unorganized data. Unlike supervised learning, unsupervised learning does not involve user-initiated training based upon example inputs with associated outputs. Rather, in unsupervised learning, the language model and the virtual reality machine learning model may organize unlabeled data according to a relationship determined by at least one machine learning method/algorithm employed by the language model and the virtual reality machine learning model. Unorganized data may include any combination of data inputs and/or machine learning outputs as described above.

In yet another embodiment, the language model and the virtual reality machine learning model may employ reinforcement learning, which involves optimizing outputs based upon feedback from a reward signal. Specifically, the language model and the virtual reality machine learning model may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to intent data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset.

It is to be understood that supervised machine learning and/or unsupervised machine learning may also comprise retraining, relearning, or otherwise updating models with new, or different, information, which may include information received, ingested, generated, or otherwise used over time.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

### Language Model Server

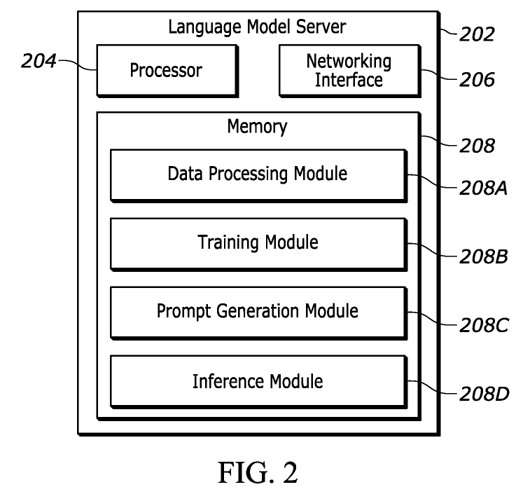

Turning now to FIG. 2, the language model server 202 may include one or more processors 204, a networking interface 206, and one or more memories 208. The memories 208 may comprise various applications for execution by the processors 204 including a data processing module 208A, a training module 208B, a prompt generation module 208C, and an inference module 208D. The language model server 202 may be connected to a database 154, which stores training data which the language model server 202 may use to train its language model. The language model server 202 may also retrieve domain parameters and/or user profile information from the database 154.

The language model server 202 may receive training data from the database 154 via networking interface 206 to train the language model. The language model server 202 may additionally receive inputs (e.g., user inputs) from the client devices 106–116 and transmit outputs (e.g., responses) to the client devices 106–116 via the networking interface 206. In some embodiments, the language model server 202 may receive inputs (e.g., input prompts) from the training environment server 302 and transmit outputs (e.g., response) to the training environment server 302.

More generally, the one or more processors 204 may include any suitable number of processors and/or processor types. For example, the processors 204 may include one or more CPUs and one or more graphics processing units (GPUs). Generally, each of the processors 204 may be configured to execute software instructions stored in the corresponding one or more memories 208. The memories 208 may include one or more persistent memories (e.g., a hard drive and/or solid-state memory) and may store one or more applications, modules, and/or models, such as the data processing module 208A, the training module 208B, the prompt generation module 208C, and/or the inference module 208D.

The networking interface 206 may enable the language model server 202 to communicate with other devices, and/or any other suitable devices or combinations thereof. The networking interface 206 may support wired or wireless communications, such as USB, Bluetooth, Wi-Fi Direct, Near Field Communication (NFC), etc. The networking interface 206 may enable the language model server 202 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

The data processing module 208A may process data before the data is used by the training module 208B to train the model. The data processing module 208A may perform tasks such as data cleaning, normalization, tokenization, and feature extraction. These preprocessing steps ensure that the data is in a suitable format for training the language model, enhancing the model’s ability to learn effectively from the data. Additionally, the data processing module 208A may transform a user input received from client devices 106–116 or a training environment server 302 to a format that is suitable for the language model to process and determine a response. In some embodiments, the language model server 202 may receive an input prompt comprising the user input, domain parameters, and/or user profile from the client device 106–116, in which the language model server 202 may transform into a format suitable for the language model.

The language model server 202 may use the training module 208B to train a language model. The training module 208B may employ various machine learning techniques such as supervised learning, unsupervised learning, and reinforcement learning to train the language model as described in FIG. 1. The training module 208B may use the training data from the database 154 to train the language model.

The language model server 202 may utilize the prompt generation module 208C to construct an input prompt for processing by the language model. To do so, the prompt generation module 208C may access the database 154 to retrieve domain parameters relevant to the training environment domain in which the user is currently engaged. These domain parameters may include, but are not limited to, a plurality of training scenarios, one or more domain-specific profiles, contextual setting data, potential user actions, and the corresponding outcomes associated with those actions. The prompt generation module 208C may then combine the user input with the retrieved domain parameters to form a unified input prompt that reflects both the user’s real-time interaction and the contextual backdrop of the training environment. In some embodiments, the prompt generation module 208C may retrieve user profile information from the database 154, and may generate an input prompt comprising the user input, the domain parameters, and the user profile. In some other embodiments, the language model server 202 may receive the input prompt directly from the training environment server 302, bypassing the need for independent prompt construction.

In some embodiments, the user device (e.g., client devices 106–116) may provide domain parameters to generate a new domain training environment. For instance, the user device may transmit domain parameters for a college classroom domain, a domain not stored in the database 154. The user device may provide domain parameters as part of the user input. The prompt generation module 208C, upon receiving the domain parameters, may store the domain and the domain parameters in the database 154.

In some embodiments, the prompt generation module 208C may also retrieve a list of available training domains stored in the database 154. The user device may then provide a selection of the list of available training domains to engage with. For example, when a user intends to begin a training session in an elementary school classroom setting, the prompt generation module 208C may present a set of domain options such as elementary school classroom, middle school classroom, high school classroom, hospital, and others to the user device. The user may then select the desired domain, such as the elementary school classroom, to initiate the corresponding training session via the user device. The user device may then transmit the selection as the user input to the language model server 202.

The inference module 208D may use the language model trained by the training module 208B to generate a response to the input prompt or the user input. The language model server 202 may receive the user input from the client devices 106–116. The language model server 202 may generate the input prompt using the prompt generation module 208C, and/or receive the input prompt from the training environment server 302. The inference module 208D may first utilize the data processing module 208A to process the input prompt or the user input to match the format expected by the trained language model. The inference module 208D may then feed the preprocessed input prompt or the user input into the language model to obtain responses.

The response generated by the language model may include updated information related to the training scenario, such as advancing the scenario narrative, presenting an outcome based on the user’s input, or modifying domain-specific profiles (e.g., character emotional states or behavioral tendencies). The language model server 202 may generate the response that includes both verbal and nonverbal cues to the client device 106–116 for rendering and display (as illustrated in FIG. 5). For instance, the response may describe nonverbal aspects such as “Character A frowned” but also may include verbal aspect such as “Character B said, ‘Hi there’.” In some embodiments, the language model server 202 may transmit the response to the training environment server 302.

Referring now to FIG. 3, the training environment server 302 may include one or more processors 304, a networking interface 306, and one or more memories 308. The memories 308 include a prompt generation module 310, a virtual reality module 312, and a conversion module 314. The virtual reality module 312 may include a generation module 312a, an update module 312b, a communication module 312c, and a synchronization module 312d.

More generally, the one or more processors 304 may include any suitable number of processors and/or processor types. For example, the processors 304 may include one or more CPUs and one or more graphics processing units (GPUs). Generally, each of the processors 304 may be configured to execute software instructions stored in the corresponding one or more memories 208. The memories 208 may include one or more persistent memories (e.g., a hard drive and/or solid-state memory) and may store one or more applications, modules, and/or models, such as the prompt generation module 310, the virtual reality module 312, and/or the conversion module 314.

The networking interface 306 may enable the training environment server 202 to communicate with other devices, and/or any other suitable devices or combinations thereof. The networking interface 306 may support wired or wireless communications, such as USB, Bluetooth, Wi-Fi Direct, Near Field Communication (NFC), etc. The networking interface 306 may enable the training environment server 302 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

Upon receiving a user input from a user device (e.g., client devices 106–116), the prompt generation module 310 may construct an input prompt. Similar to the prompt generation module 208C of the language model server 202, the prompt generation module 310 may access the database 154 to retrieve relevant domain parameters associated with a domain of the active training environment in which the user is currently engaged. The domain parameters may include, but not limited to, a plurality of training scenarios, one or more domain-specific profiles, contextual setting data, a plurality of potential user actions, and corresponding outcomes. The user input may correspond to an action performed by the user within one of the training scenarios available in the selected domain. The prompt generation module 310 may then combine the user input with the retrieved domain parameters to generate a structured input prompt, which may subsequently be transmitted to the language model server 202 for processing. In some embodiments, the prompt generation module 310 may retrieve user profile information from the database 154, and may generate an input prompt comprising the user input, the domain parameters, and the user profile.

In some embodiments, the user device (e.g., client devices 106–116) may provide domain parameters to generate a new domain training environment. For instance, the user device may transmit domain parameters for a college classroom domain, a domain not stored in the database 154. The user device may provide domain parameters as part of the user input. The prompt generation module 310, upon receiving the domain parameters, may store the domain and the domain parameters in the database 154.

In some embodiments, the prompt generation module 310 may also retrieve a list of available training domains stored in the database 154. The user device may then provide a selection of the list of available training domains to engage with. For example, when a user intends to begin a training session in an elementary school classroom setting, the prompt generation module 310 may present a set of domain options such as elementary school classroom, middle school classroom, high school classroom, hospital, and others to the user device. The user may then select the desired domain, such as the elementary school classroom, to initiate the corresponding training session. The user device may then transmit the selection as the user input to the training environment server 302.

The virtual reality module 312 may generate or update a virtual reality training environment. The virtual reality training environment may comprise one or more virtual characters and a training setting based on domain parameters, a response, and a user profile. The training environment server 302 may receive different kinds of user inputs. For instance, the training environment server 302 may receive a user input comprising a selection of a domain for a training environment from a plurality of domains. In such instance, the training environment server 302 may retrieve a plurality of domain parameters associated with the selected domain from the database 154, and the generation module 312a may generate the virtual reality training environment based on the plurality of domain parameters. Such instance may be reflected in FIG. 4A. In another instance, the training environment server 302 may receive a user input comprising custom domain parameters for a creation of a new training environment for a specific domain. In such instance, the generation module 312a may generate the virtual reality training environment based on the custom domain parameters, store the custom domain and the custom domain parameters in the database 154, and provide as another option for the user to select.

In yet another instance, the user input may comprise an action performed by the user within one of the training scenarios available within the virtual reality training environment. The training environment server 302 may generate an input prompt using the prompt generation module 310, and transmit the input prompt to the language model server 202. The language model server 202 may process the input prompt and generate a response to the input prompt. The language model server 202 may then transmit the response back to the training environment server 302, and the update module 312b may update the virtual reality training environment based on the response. The updating may modify behavior of one or more characters in the virtual reality training environment, an outcome resulting from the action in the scenario, training setting, and others. Such instance may be reflected in FIG. 4B.

The virtual reality machine learning model may generate or update a virtual reality training environment based on domain parameters, the response, and/or user profile associated with a specific training domain. The virtual reality training environment may comprise one or more virtual characters (e.g., according to the domain-specific character profiles) and a training setting (e.g., according to the contextual setting data). The virtual reality machine learning model may generate or update domain-specific character profiles, including facial expressions, body movements, voice tone, and other nonverbal behaviors that reflect the emotional and contextual state of the characters. For example, a character may adopt a defensive posture and raise their voice in response to a confrontational user action, enhancing the realism and feedback of the training scenario. Similarly, the virtual reality machine learning model may generate or modify environmental elements of the simulation, such as background settings, lighting, ambient sounds, and object placement. These changes may reflect the evolving state of the training scenario or user-triggered events, allowing the environment to adapt dynamically.

The virtual reality machine learning model may generate or update a virtual reality environment based on a combination of domain parameters, user profiles, and/or responses generated by the language model server 202. The virtual reality machine learning model may translate text-based representations of these inputs into corresponding virtual reality elements, including 3D environments, virtual characters, and interactive objects. For example, in response to output received from the language model, the virtual reality machine learning model may dynamically update facial expressions, gestures, tone, or posture of virtual characters to reflect emotional or situational changes as described in the response. The virtual reality machine learning model may also alter environmental aspects such as lighting, background scenery, or spatial layout to align with the evolving scenario.

The communication module 312c may facilitate the exchange of information between the training environment server 302 and the language model server 202. Specifically, the communication module 312c may transmit the generated input prompt, comprising user input, domain parameters, and/or user profile, to the language model server 202 and receive a corresponding response. Once the response is received, the communication module 312c may forward the response to the virtual reality machine learning model, which uses the response to update the virtual reality training environment. These updates may include modifications to virtual character behavior, environmental settings, or the progression of the training scenario, enabling a seamless and context-aware simulation experience.

The synchronization module 312d may support multi-user participation within a shared virtual reality training environment. The synchronization module 312d may coordinate actions, events, and system states across multiple client devices to ensure a consistent and unified training experience for all users, which may include synchronizing user inputs, character interactions, environmental changes, and scenario progression in real time. The synchronization module 312d may enable multiple users, such as trainees, instructors, or evaluators, to participate simultaneously within the same training scenario. For example, two users may engage in a collaborative classroom simulation where one plays the role of a teacher and the other observes or provides real-time feedback. The synchronization module 312d may ensure that all users observe the same virtual character behaviors, scenario developments, and environment updates, regardless of their physical location or device.

The training environment server 302 may utilize the conversion module 314 to convert a user input into written texts. The user input may comprise written, verbal, and/or nonverbal components. For example, the user input may be a voice command of the user or the user nodding their head for a “yes” response. The conversion module 314 may interpret and translate verbal components into written texts. In some embodiments, the conversion module 314 may also interpret and translate nonverbal actions performed by the user within the virtual reality training environment, such as gestures, facial expressions, or body movements, into corresponding textual representations. These transcribed verbal and nonverbal inputs may then be incorporated into an input prompt and transmitted to the language model server 202 for processing, enabling a more comprehensive and context-aware response generation. The conversion module 314 may implement any suitable techniques for translating verbal and nonverbal components into written text. Such techniques may include, for example, machine learning models, rule-based processing systems, signal processing algorithms, or combinations thereof.

FIG. 4A illustrates a combined block and logic diagram that depicts the generation of a virtual reality training environment. A user using a user device 402 may interact with a training environment server comprising a prompt generation module 404 and a virtual reality module 406 to generate a virtual reality training environment. The user device 402 may correspond to one or more of client devices 106–116 of FIG. 1, the prompt generation module 404 may correspond to a prompt generation module 310 of FIG. 3, and the virtual reality module 406 may correspond to a virtual reality module 312 of FIG. 3. A database 408 may already comprise a plurality of domains, with each domain comprising corresponding domain parameters, and different user profiles. The database 408 may correspond to database 152 of FIG. 1.

In step S402, the prompt generation module 404 may retrieve different domains stored in the database 408 that the virtual reality module 406 may generate a virtual reality training environment of, and provide the different domains to the user device 402 (e.g., client devices 106–116). For instance, the plurality of domains may be elementary school classroom, middle school classroom, high school classroom, hospital front desk, etc.

In step S403, the user device 402 may provide a user input comprising a selection of a domain for a virtual reality training environment from the different domains to the prompt generation module 404. For instance, the user device may transmit a selection of the elementary school classroom among the plurality of domains. The user device 402 may provide the selection via a voice command, written text, clicking an option, or other suitable means to communicate the selection. In some embodiments, the user device may also provide user credential as part of the user input to the prompt generation module 404 via the user device 402.

In step S404, the prompt generation module 404 may utilize the user input including the selection to retrieve domain parameters associated with the selected domain from the database 408. The domain parameters may comprise, but not limited to, different training scenarios, one or more domain-specific profiles, contextual setting data, potential user actions, and corresponding outcomes. In some embodiments, the user input may comprise user credential, and the prompt generation module 404 may retrieve a user profile matching the user credential from the database 408. The user profile may contain historical data such as previous user inputs, system-generated responses, the user’s current stage or progress within a scenario, and other personalized training information. In some other embodiments, if the user or user device 402 is accessing the domain for the first time, the prompt generation module 404 may generate a new user profile and store the new user profile in the database 408 for future reference and personalization.

In step S406, the prompt generation module 404 may transmit the domain parameters and/or the user profile to the virtual reality module 406. The virtual reality module 406 may then generate a virtual reality training environment by inputting the domain parameters and/or the user profile into a virtual reality machine learning model. The virtual reality training environment may include one or more virtual characters, a contextual training setting, and other interactive elements configured based on the domain parameters and/or the user profile.

As an illustrative example, the domain parameters may comprise a set of training scenarios tailored to a classroom management domain, including virtual student profiles, behavioral triggers, classroom layouts, and predefined environmental conditions (e.g., noise level, seating arrangements). The user profile may indicate that the user is in the early stages of training and has previously struggled with de-escalation techniques. Based on this information, the virtual reality machine learning model may generate a scenario in which multiple students begin to talk over one another, challenging the user's classroom control skills. The virtual characters may exhibit behaviors such as interrupting, ignoring instructions, or displaying frustration, and the virtual setting may reflect a realistic elementary school classroom.

In step S408, after generating the virtual reality training environment, the virtual reality module 406 may render and display the virtual reality training environment to the user via the user device.

FIG. 4B illustrates a combined block and logic diagram that depicts updating a virtual reality training environment based on a response generated from a language model. A user using a user device 402 may currently be in an active session of a virtual reality training environment, and may be providing different user inputs depending on a scenario in the virtual reality training environment. The user device 402 may be communicating with a training environment server comprising a prompt generation module 404 and a virtual reality module 406. The user device 402 may correspond to client devices 106–116 of FIG. 1, the prompt generation module 404 may correspond to a prompt generation module 310 of FIG. 3, and the virtual reality module 406 may correspond to a virtual reality module 312 of FIG. 3. The training environment server may be in communication with a large language model server, and the large language model server include a large language model 410. A database 408 may correspond to a database 154 of FIG. 1, and may store domain parameters for the current virtual reality training session domain and different user profiles.

In step S402, the user device 402 may provide a user input, where the user input includes at least one action performed in response to a scenario within the virtual reality training environment. For example, if the selected domain is an elementary school training session and the current scenario involves teaching music to a group of children, the user device may provide a verbal directive such as, “Let’s be quiet and have a seat.” This input may reflect the user’s attempt to manage the classroom.

The user input may be a voice command or as written text. In some embodiments, the training environment server may generate a plurality of selectable options for progressing the scenario. In such cases, the user device may provide a selection of the available options, allowing for guided interaction within the training environment while still capturing meaningful decision-making behavior.

In step S404, the prompt generation module 404 may retrieve domain parameters associated with the currently active virtual reality training environment and generate an input prompt that includes both the domain parameters and the user input. In some embodiments, the prompt generation module 404 may also retrieve the user profile of user from the database 408 and incorporate relevant profile data into the input prompt.

In step S408, the prompt generation module 404 may transmit the input prompt to the large language model 410. In step S412, the large language model 410 may process the input prompt and generate a corresponding response, which may be transmitted to the virtual reality module 406. The response may include instructions for updating the virtual environment—such as modifications to the setting, reactions from one or more virtual characters, or the transition to a subsequent scenario within the training session.

As an illustrative example, in response to the user input “Let’s be quiet and have a seat,” the generated response from the language model may comprise a series of character behaviors and environmental cues that reflect varying levels of compliance and emotional states. For instance, one virtual student, [Jason], might immediately sit down and open his notebook, while another student, [Tasha], crosses her arms and mutters under her breath, “Why should we? You never listen to us anyway.” Meanwhile, [Lily] hesitates, looking nervously between her classmates and the user. The response may also include a transition to a new situation or scenario, for example, the classroom atmosphere growing tense as all eyes turn to the user, waiting to see how they will respond next.

In step S412, upon receiving the response, the virtual reality module 406 may update the virtual reality training environment based on the response using the virtual reality machine learning model. The update may modify the behavior of one or more virtual characters, the outcome of the scenario, and/or elements of the training setting. These modifications may include adjustments to nonverbal behaviors, such as facial expressions, gestures, or posture, as well as verbal behaviors, including tone of voice, speech cadence, and spoken responses. These dynamic updates allow the environment to reflect the emotional tone and narrative progression generated by the language model, resulting in a more immersive and contextually responsive training experience. Additionally, the generated response may be converted into voice output, enabling virtual characters to audibly speak their lines using synthesized speech that reflects the intended tone and emotion.

As an illustrative example, based on the response generated by the language model, the virtual reality machine learning model may update the virtual reality training environment to reflect the specific emotional dynamics and character behaviors described. For instance, the model may animate [Jason] sitting quietly with his notebook open, rendering a calm facial expression and relaxed posture. At the same time, the model may animate [Tasha] crossing her arms, turning slightly away from the user, and delivering her line with a defiant tone and narrowed eyes, capturing her frustration and disengagement. [Lily] may be shown shifting uncomfortably in her seat, glancing around anxiously and fidgeting with her hands to visually convey hesitation and tension. The classroom environment itself may also be updated to reflect the mood, such as dimming ambient sound to highlight the silence following [Tasha]’s comment, or subtly slowing background animations to heighten the sense of anticipation. The virtual reality machine learning model may provide these synchronized updates to character expressions, voice modulation, posture, and environmental cues based on the semantic and emotional content of the language model’s response, creating a cohesive and lifelike simulation experience.

In some embodiments, upon receiving the response, the virtual reality module 406 may communicate with the database 408 to update the user profile of user. This update may include storing the current training progress, such as the newly provided user input from step S402 and the corresponding response generated by the large language model in step S412. Storing this information in the user profile may allow the training environment server to track scenario progression, capture decision history, and support personalized training experiences in future sessions.

In step S414, the virtual reality module 406 may display the updated virtual reality training environment to user via the user device 402. The updates may reflect the changes generated in response to the user’s input, including modified character behaviors, adjusted environmental elements, and scenario progression, allowing the user to experience the training environment in a dynamic and contextually responsive manner.

FIG. 5 illustrates an example communication session between a user using a user device and the language model during an active training session within an elementary classroom domain. The user device may correspond to client devices 106–116 of FIG. 1, and a language model server 202 may host the language model of FIG. 5. The session may begin when the user device initiates the training environment by providing a domain selection via text or voice, shown as block 501, prompting the language model to generate an initial scenario, shown as block 502, which introduces the context and various virtual characters. After reviewing the scenario, the user device may provide a response, such as a verbal or written input, shown in block 504. Based on this input, the language model generates a corresponding response in block 506, further progressing the scenario. As depicted, the user device may engage in an ongoing, interactive dialogue with the language model server to navigate the training environment. This interaction enables the training to evolve dynamically based on the user’s decisions. Additionally, while the user device may communicate directly with the language model server to simulate the experience in a text-based format, a virtual reality training system may also employ a virtual reality server to render the training session in a virtual reality environment. As reflected in FIG. 5, the language model may use the responses generated by the language model (e.g., blocks 502, 506, 510) and the user inputs (e.g., blocks 501, 504, 508) to update virtual characters, environmental conditions, and scenario progression.

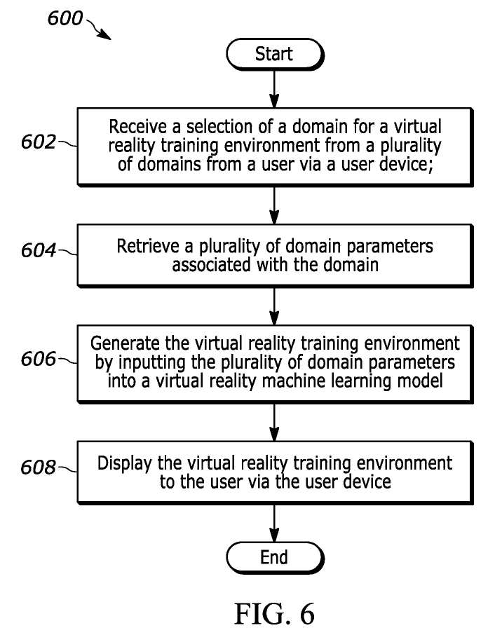

FIG. 6 illustrates an example method 600 for generating a virtual reality training environment. The method may be implemented in a set of instructions stored on a computer-readable memory and executable at one or more processors 304 of a training environment server 302. A language model server 202 may include the language model used to generate a response.

At block 602, the one or more processors may receive a selection of a domain for a virtual reality training environment from a plurality of domains from a user via a user device. At block 604, the one or more processors may retrieve a plurality of domain parameters associated with the domain. The plurality of domain parameters may comprise at least a plurality of training scenarios, one or more domain-specific profiles, contextual domain-specific data, a plurality of potential user actions, and corresponding outcomes. At block 606, the one or more processors may generate the virtual reality training environment by inputting the plurality of domain parameters into a virtual reality machine learning model. The virtual reality training environment may comprise one or more characters and a training setting based on the plurality of domain parameters. At block 608, the one or more processors may display the virtual reality training environment to the user via the user device. In some embodiments, the one or more processors may display the virtual reality training environment to multiple computing devices.

In some embodiments, the method 600 may include receiving a user input comprising at least an action performed by the user for a scenario of the plurality of training scenarios within the virtual reality training environment via the user device. The user input may include a voice command of the user. The method 600 may include generating an input prompt comprising the user input and the plurality of domain parameters and transmit the input prompt to a large language model. The method 600 may then include receiving a response from the large language model. The method 600 may include updating the virtual reality training environment based on the response. The response may be a voice output in response to the user input by the one or more characters. The update may modify at least one of a behavior of at least one character from the one or more characters, an outcome from the corresponding outcomes, or the training setting.

In some embodiments, the method 600 may include generating a plurality of user selectable options to proceed with the scenario, wherein the user input is a user selection from the plurality of user selectable options.

In some embodiments, the method 600 may include generating a user profile for the user in a memory system, and store the user input and the response in the user profile. In some other embodiments when generating the virtual reality training environment by inputting the plurality of domain parameters into the virtual reality machine learning mode, the method 600 may input the user profile into the virtual reality machine learning model to generate the virtual reality training environment for the user.

In some embodiments, the method 600, when modifying at least one of the behaviors of at least one character from the one or more characters, may include adjusting nonverbal behaviors of the one or more characters including facial expressions, gestures, or posture. In some other embodiments, the method 600, when modifying at least one of the behaviors of at least one character from the one or more characters, may include adjusting verbal behaviors of the one or more characters including tone, speech cadence, and the response.

### Additional considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for generating a virtual reality training environment through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for generating a virtual reality training environment, the method comprising:
receiving, by one or more processors, a selection of a domain for a virtual reality training environment from a plurality of domains from a user via a user device;
retrieving, by the one or more processors, a plurality of domain parameters associated with the domain, the plurality of domain parameters comprising at least a plurality of training scenarios, one or more domain-specific profiles, contextual domain-specific data, a plurality of potential user actions, and corresponding outcomes;
generating, by the one or more processors, the virtual reality training environment by inputting the plurality of domain parameters into a virtual reality machine learning model, wherein the virtual reality training environment comprises one or more characters and a training setting based on the plurality of domain parameters; and
displaying, by the one or more processors, the virtual reality training environment to the user via the user device.

2. The method of claim 1, further comprising:
receiving, by the one or more processors, a user input comprising at least an action performed by the user for a scenario of the plurality of training scenarios within the virtual reality training environment via the user device;
generating, by the one or more processors, an input prompt comprising the user input and the plurality of domain parameters;
transmitting, by the one or more processors, the input prompt to a large language model;
receiving, by the one or more processors, a response from the large language model; and
updating, by the one or more processors, the virtual reality training environment based on the response, wherein the update modifies at least one of a behavior of at least one character from the one or more characters, an outcome from the corresponding outcomes, or the training setting.

3. The method of claim 2, wherein the user input includes a voice command of the user.

4. The method of claim 2, further comprising:
generating, by the one or more processors, a plurality of user selectable options to proceed with the scenario, wherein the user input is a user selection from the plurality of user selectable options.

5. The method of claim 2, wherein the response is a voice output in response to the user input by the one or more characters.

6. The method of claim 2, further comprising:
generating, by the one or more processors, a user profile for the user in a memory system; and
storing, by the one or more processors, the user input and the response in the user profile.

7. The method of claim 6, wherein generating the virtual reality training environment by inputting the plurality of domain parameters into the virtual reality machine learning model further comprises:
inputting, by the one or more processors, the user profile into the virtual reality machine learning model to generate the virtual reality training environment for the user.

8. The method of claim 2, wherein modifying at least one of the behavior of at least one character from the one or more characters further comprises:
adjusting, by the one or more processors, nonverbal behaviors of the one or more characters including facial expressions, gestures, or posture.

9. The method of claim 2, wherein modifying at least one of the behavior of at least one character from the one or more characters further comprises:
adjusting, by the one or more processors, verbal behaviors of the one or more characters including tone, speech cadence, and the response.

10. The method of claim 1, wherein displaying the virtual reality training environment further comprises:
displaying, by the one or more processors, the virtual reality training environment to multiple computing devices.
